(19) United States
(12) Patent Application Publication
(10) Pub. No.: US 2009/0153298 A1
(43) Pub. Date: Jun. 18, 2009

(54) SYSTEM AND METHOD FOR FORECASTING LOCATION OF MOBILE OBJECT

(75) Inventors: Jichuan Xu, Beijing (CN); Yingfei Wu, Beijing (CN); Zhuocheng Jia, Shanghai (CN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/956,052

(22) Filed: Dec. 13, 2007

(51) Int. Cl. H04Q 5/22

(52) U.S. Cl. 340/10.1

(57) ABSTRACT

A method and system forecasting the location of a mobile object in a network by utilizing Radio Frequency Identification (RFID) technology. The network consists of a plurality of nodes connected with each other, at lease one RFID reader having a monitoring range is disposed at each node of the network and at least one RFID tag is physically attached to the mobile object. The method includes the steps of generating a record data related to the mobile object when the mobile object moves within the monitoring range of an RFID reader disposed at a node and statistically processing the record data to estimate the location of the mobile object.

### BACKGROUND OF THE INVENTION

1. Field of the Invention

The present invention generally relates to an object monitoring and tracking system and method. More particularly, this invention relates to a system and method for problilistically forecasting the location of a moving object based on statistically processing the record data of location information of the moving object.

2. Related Art

Object tracking and monitoring technology is now widely applied in industries and to people's lives. An example of the circumstances for applying the technology is the mining industry where mineworkers normally carry out the mining operation underground. The underground mining operations typically require the workers to travel within a complex arrangement of underground passageways in the mine. A large amount of underground passageways are connected to form a complex network for providing commuting channels for the workers and conveying ores to the surface cites.

In order to improve the safety of underground mineworkers, different technologies have been developed to track the moving paths of the mineworkers, one of which is Radio Frequency Identification (RFID) technology. In a monitoring system using RFID technology, an RFID tag, electronically programmed with unique identification information, is physically attached to a worker. A plurality of RFID readers are disposed at different underground locations in the mine. The reader emits radio waves in a range of several centimeters to 50 meters or more, depending on the output power of the reader, thereby establishing a predetermined electromagnetic zone. When an RFID tag passes through the electromagnetic zone, the RFID reader decodes the data encoded in the RFID tag and sends the data to an external server for processing. Therefore, the RFID readers need to be distributed strategically in the underground mine, to cover as much underground area as possible.

FIG. 1 illustrates a known underground mine-monitoring system employing RFID technology. As illustrated in FIG. 1, an underground network is formed by a plurality of nodes (intersections) A-C and E-N connected by the underground passageways extending between the nodes. At each of the nodes, at least one REID reader is arranged to communicate with an RFID tag attached to an underground mineworker. Assuming that each of the RFID readers has a covering range of 50 meters, there are blind zones in the passageways longer than 100 meters where the RFID readers disposed at both ends of the passageway cannot establish a communication with the RFID tag. For example, assuming that the passageways BA, BC and BG in FIG. 1 are all longer than 100 meters and the mineworker carrying an RFID tag is moving out of the covering range of REID reader B, which is the intersection of the three passageways, it is not possible to determine the location or moving direction of the mineworker until he moves within the covering range of the next RFID reader, which could be RFID reader A, RFID C or RFID G. Therefore, in the event a mine catastrophe happens when the mineworker is in one of the blind zones, the rescuing force needs to check every blind zone to search for the trapped mineworker. Normally, the searching and rescuing is performed randomly or in a certain order until the worker is located. However, this approach raises the potential issue of wasting precious rescuing time if the mineworker is trapped in a blind zone which would be searched last.

Therefore, it would be very advantageous to forecast the moving direction and the location of mineworkers. A rescue subsequently performed based on the predicted location of the mineworkers would be greatly expedited.

### SUMMARY OF THE INVENTION

In view of the foregoing and other problems, the present invention provides a method for forecasting the location of a mobile object in a network by utilizing Radio Frequency Identification (RFID) technology, wherein the network consists of a plurality of nodes connected with each other, at lease one RFID reader having a monitoring range is disposed at each node of the network and at least one REID tag is physically attached to the mobile object. The method includes the steps of generating a record data related to the mobile object when the mobile object moves within the monitoring range of an REID reader disposed at a node, and statistically processing the record data to estimate the location of the mobile object. Moving within the monitoring range includes both entering the signal range of a reader and further movement that continues to be in the range of that reader.

In one aspect of the method, statistically processing the record data to estimate the location of the mobile object includes generating a statistical model and applying the statistical model to the record data. Preferably, generating a statistical model and applying the statistical model to the record data includes generating a Bayesian network model based on the network and applying the Bayesian network model to the record data.

In another aspect of the method, statistically processing the record data to estimate the location of the mobile object includes generating a location constraints model dependent on a plurality of parameters and applying the location constraints model to the record data. Preferably, the plurality of parameters is selected from the group consisting of moving velocity of the mobile object, moving history of the mobile object, conditions of the network, the time for forecasting the location of the mobile object and any combination thereof.

In yet another aspect of the method, the method further includes generating an output data corresponding to the estimated location of the mobile object and transmitting the output data to a display.

In yet another aspect of the method, the method her includes generating an output data corresponding to the estimated location of the mobile object and transmitting the output data to a route optimization engine for creating an optimal moving route for the mobile object.

The present invention also provides a computer readable medium having computer readable program for operating on a computer for forecasting the location of a mobile object in a network by utilizing Radio Frequency Identification (RFID) technology, wherein the network consists of a plurality of nodes connected with each other, at lease one RFID reader having a monitoring range is disposed at each node of the network and at least one RFID tag is physically attached to the mobile object. The method includes the steps of generating a record data related to the mobile object when the mobile object moves within the monitoring range of an RFID reader disposed at a node, and statistically processing the record data to estimate the location of the mobile object.

The present invention also provides a system for forecasting the location of a mobile object in a network by utilizing Radio Frequency Identification (RFID) technology, wherein the network consists of a plurality of nodes connected with each other, at lease one RFID reader having a monitoring range is disposed at each node of the network and at least one REID tag is physically attached to the mobile object. The system includes a record data generating component for generating a record data related to the mobile object when the mobile object moves within the monitoring range of an RFID reader disposed at a node and a statistical processing component for statistically processing the record data to estimate the location of the mobile object.

Although an embodiment of the forecasting method and system will be described in connection with a network formed by underground passageways of a mine, it should be recognized that the application of the method and system according to the present invention is not limited to underground networks. Rather, the method is applicable to any other suitable circumstances, where forecasting of a moving direction of an object in a network is required.

### BRIEF DESCRIPTION OF THE DRAWINGS

These and other features, benefits and advantages of the present invention will become apparent by reference to the following text figures, with like reference numbers referring to like structures across the views, wherein:

FIG. 1 is schematic view illustrating a known underground mine monitoring system using RFID technology, wherein an underground network is formed by a plurality of underground passageways connected by intersections at which an RFID reader is disposed; and

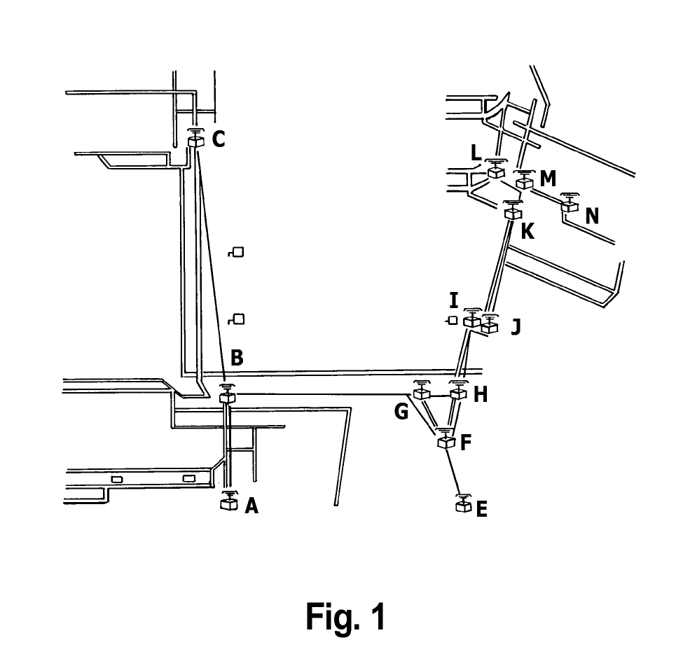

FIG. 2 is a block diagram of the system for forecasting locations of a mobile object according to one exemplary embodiment of the present invention; and

FIG. 3 is a flow chart illustrating the steps of the method for forecasting locations of a mobile object according to one exemplary embodiment of the present invention.

### DETAILED DESCRIPTION OF THE INVENTION

The present invention now will be described in detail hereinafter with reference to the accompanying drawings, in which exemplary embodiments of the invention are shown. However, this invention may be embodied in many different forms and should not be construed as limited to the embodiments set forth herein. Like numerals refer to like elements throughout.

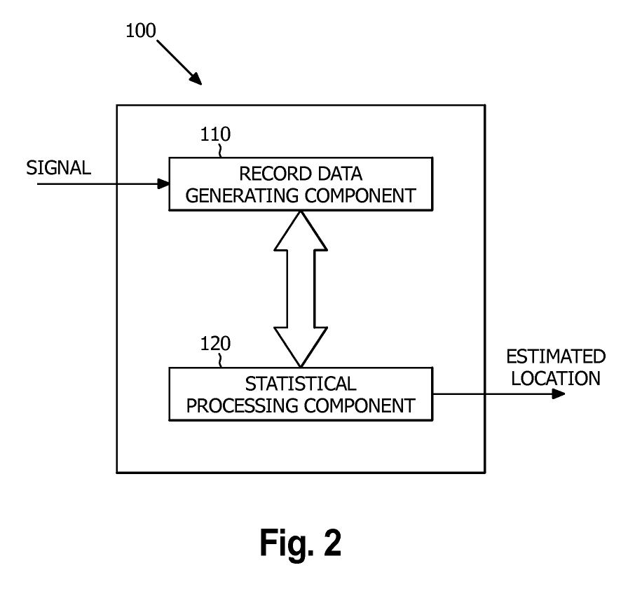

FIG. 2 is a block diagram schematically illustrating a system for forecasting locations of a mobile object according to one exemplary embodiment of the present invention. The system 10 includes a record data generating component 110 and a statistical processing component 120 communicating with the record data generating component 110. The record data generating component 110 receives wireless signals from an RFID reader through a wireless protocol or through hardware, such as optical fibers, and generates a computer-readable record data related to a mineworker carrying an RFID tag when the mineworker moves within the monitoring range of the RFID reader. Note that the record data generating component 110 can also be configured to receive initial computer-readable data processed from the raw signals and further process the initial computer-readable data to obtain the record data related to the mineworker. The record data related to the mineworker can be, but is not limited to, the approximate current location of the worker, the location of the RFID reader which detects the entering of the RFID tag of the worker within the monitoring ranges thereof the moving velocity of the worker, the personal information of the worker and so on. The record data is subsequently transmitted, processed and utilized by the statistical processing component 120 to estimate the location of the mobile object. Preferably, the statistical processing component 120 generates an output data that indicates the estimated location of the worker and the probability of the worker being at this location. More preferably, the output data is transmitted to a client for processing and displaying the output data.

It should be recognized that the component can be any computer-related entity as long as it is capable of executing the functionality thereof. For example, the component includes but not limited to hardware, software and a combination of hardware and software.

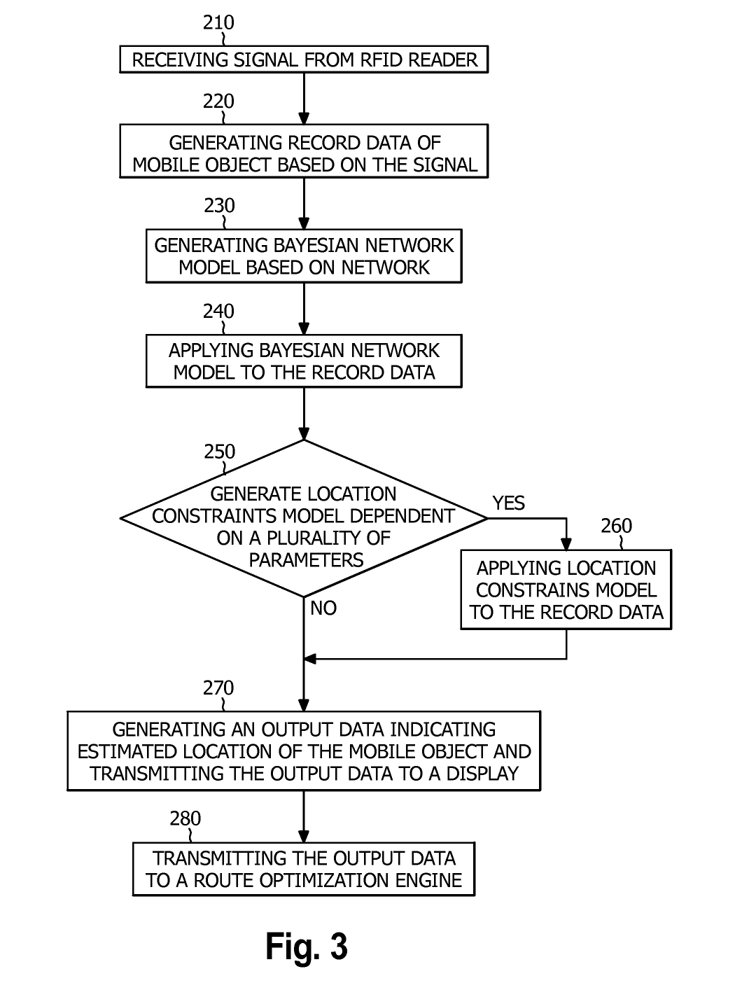

Referring now to FIG. 3, there is illustrated a flow chart of the steps of a method for forecasting locations of a mobile object according to one exemplary embodiment of the present invention. Although the steps of the embodiment are shown and described as a series of acts, it should be recognized that the present invention is not limited by the order of acts, as some acts may occur in different orders and/or concurrent with other acts. Moreover, not all illustrated acts are required to implement the embodiment of the method according to the present invention.

The exemplary embodiment of the method according to the present invention will be described hereafter in connection with an underground mine scenario where a mineworker carrying an RFID tag moves in an underground network composed of a plurality of passageways and an RFID reader is arranged at each intersection of the passageways.

At step 210 of the embodiment, the record data generating component 110 of FIG. 2 receives wireless signals transmitted from an REID reader. At step 220, the record data generating component 110 generates a record data related to the mineworker based on the received wireless signals. At step 230, a statistical model is generated to statistically process the record data. In this exemplary embodiment, a Bayesian network model is generated based on the conditions of the underground mine network, the personal information of the worker and the properties of the mining tasks. However, it should be recognized that the present invention is not limited to the Bayesian network model.

At step 240, the Bayesian network model is applied to the record data to statistically process the record data. For example, the record data is related to the current and history locations of the mineworker and the current moving velocity of the mineworker. The Bayesian network model is applied to the data to generate output data related to the next possible location of the mineworker.

Optionally, a location constraints model depending on a plurality of parameters is generated at step 250, and the location constraints model is further applied to the record data at step 260 to adjust the estimated location of the mineworker. The location constraints model is generated depending on a plurality of parameters, including but not limited to, parameters of the mine conditions, personal moving preferences of the mineworker, the types of mining tasks the mineworker is conducting, mining planning strategies and the time at which the mining is performed,

Optionally, an output data is generated corresponding to the estimated location of the mobile object and further transmitted to a display at step 270. Further, at step 280, the output data can be transmitted to a route optimization engine in the system, which creates an optimal moving route for the mineworker based on the output data.

The following is a description of how to generate and apply a Bayesian network model according to the underground mine scenario.

Assuming that the mineworkers are moving to the entrance(s) of the mine when a catastrophe happens, a Bayes chart can be generated based on the locations of the RFID readers disposed at the intersections of the underground passageways. The following Bayes Chart 1 simulates one of the scenarios of the underground network with Nodes A-C, C0, E-H and L.

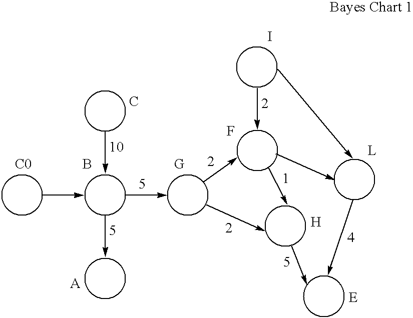

If Node C is the entrance through which a mineworker enters the mine and Nodes A and E are the entrances through which the mineworker intends to exit the mine, the worker has many different options of routes to take. For example, the worker may take the C-B-A route, C-B-G-H-E route or C-B-G-F-L-B and so on, depending on a plurality of conditions, such as the current location of the worker. For example, if the worker is in the passageway between Nodes F and H, it is more likely that the worker will take the C-B-G-F-H-E route to minimize the distance he has to cover. Therefore, this embodiment of the present invention adopts a Dijkstra algorithm to calculate the most possible route, which covers the shortest distance to an entrance.

The following Bayes Chart 2 simulates a scenario where a worker is detected to be currently located at Node B and the next location of the worker needs to be estimated.

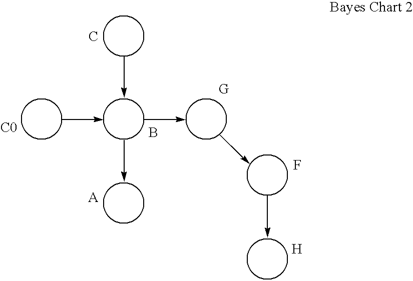

With regard to this scenario, this embodiment of the method of the present invention utilizes statistic probabilities based on history record of the locations of the worker and further obtains a probability of the next location through diagnostic reasoning.

Specifically, this embodiment obtains the probability of the worker moving from Node B to Node Aⱼ (j=1, 2 . . . m) in the following simplified Bayes Chart 3.

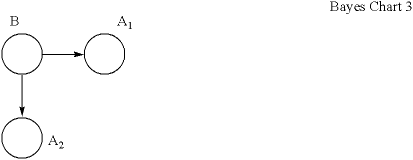

Given that Nⱼ is statistically the number of times the worker moving from Node B to Node Aⱼ according to the history record stored in an outside database, the probability of the worker moving from Node B to Node Aⱼ is defined by the following Equation 1:

$$P ( {A}_{j} \vert B ) = \frac{{N}_{j}}{{\sum }_{j = 1}^{m} {N}_{j}} \qquad Equation 1$$

Considering that the previous moving route of the worker has an impact on the probability of moving from Node B to Node Aⱼ, the following Bayes Chart 4 simulates the situation where the worker has moved from Node Cᵢ (i=1, 2, . . . n) to Node B and is subsequently moving from Node B to Node Aⱼ.

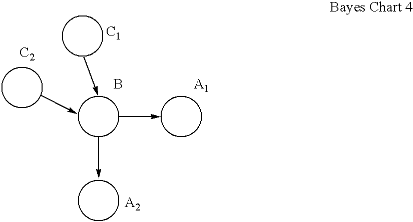

Given that Nᵢⱼ is statistically the number of times the worker moving along the route Cᵢ->B->Aⱼ according to the history record, the probability of the worker moving from Node Cᵢ to Node Aⱼ passing Node B is defined by the following Equation 2:

$$P ( {A}_{j} \vert B ⋂ {C}_{i} ) = \frac{{N}_{ij}}{{\sum }_{j = 1}^{m} {N}_{ij}} \qquad Equation 2$$

In condition that a catastrophe happens and the entrance at Node A_{j′} is blocked and the worker needs to go back and take another route, the model needs to obtain the probability of the worker moving back to Node B and subsequently moving on to Node A_{j≠j′}. Given that N_{j′j} is statistically the number of times the working moving along the route A_{j′}->B->A_{j≠j′}, the probability of the worker moving from Node A_{j′} to Node A_{j≠j′} passing Node B is defined by the following Equation 3:

$$P ( {A}_{j ( j \neq {j}^{′} )} \vert B ⋂ {A}_{{j}^{′}} ) = \frac{{N}_{{j}^{′} j}}{{\sum }_{j = 1}^{m} {N}_{{j}^{′} j} - {N}_{{j}^{′} {j}^{′}}} \qquad Equation 3$$

Therefore, the probability of the working moving from Node Cᵢ to Node B and then A_{j≠j′} is defined by the following Equation 4:

P(A_{j(j≠j′)}|B∩Cᵢ∩˜Aⱼ)=P(A_{j(j≠j′)}|B∩Cᵢ)+P(Aⱼ|B∩Cᵢ)×P(A_{j(j≠j′)}|B∩Aⱼ) Equation 4

The following Bayes Chart 5 shows the situation under which the worker enters the mine through the entrance at Node C or through the entrance at Node I and needs to exit the mine through Node H. The worker has the options of taking the route G->H or F->H. The method and system according to one embodiment of the invention obtain probabilities of each route.

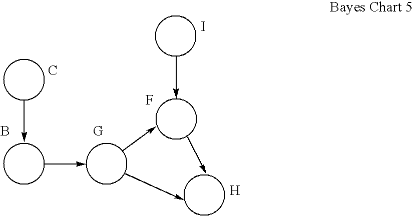

The following simplified Bayes Chart 6 simulates the situation where the worker passes Node Bₖ (k=1, 2 . . . l) and moves to Node Aⱼ (j=1, 2 . . . m).

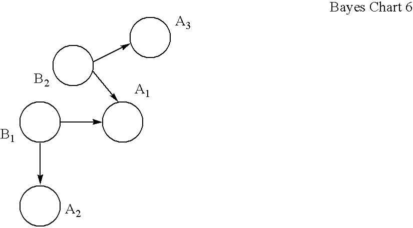

Given that Nₖ is statistically the number of times the worker moving to Node Bₖ according to the history record, the probability of moving to Node Bₖ is defined by the following Equation 5:

$$P ( {B}_{k} ) = \frac{{N}_{k}}{{\sum }_{k = 1}^{l} {N}_{k}} \qquad Equation 5$$

Given that Nₖⱼ is statistically the number of times the worker moving from Node Bₖ to Node Aⱼ according to the history record, the probability of the worker moving to Node Aⱼ from Node Bₖ is defined by the following Equation 6:

$$P ( {A}_{j} \vert {B}_{k} ) = \frac{{N}_{kj}}{{\sum }_{j = 1}^{m} {N}_{kj}} \qquad Equation 6$$

Thus, the probability of the worker arriving at Node Aⱼ is defined by the following Equation 7:

$$P ( {A}_{j} ) = {\sum }_{k = 1}^{l} P ( {A}_{j} \vert {B}_{k} ) \times P ( {B}_{k} ) \qquad Equation 7$$

Therefore, the probability of the worker moving from Node Bₖ and arriving at Node Aⱼ is defined by the following Equation 8:

$$P ( {B}_{k} \vert {A}_{j} ) = \frac{P ( {A}_{j} \vert {B}_{k} ) \times P ( {B}_{k} )}{P ( {A}_{j} )} \qquad Equation 8$$

Similarly, considering the previous moving route of the worker has an impact on the probability of moving from Node Bₖ to Node Aⱼ, the following Bayes Chart 7 simulates the situation where the worker has moved from Node Cᵢ (i=1, 2, . . . n) to Node Bₖ (k=1, 2, . . . l), and subsequently moves from Node Bₖ to Node Aⱼ (j=1, 2 . . . m).

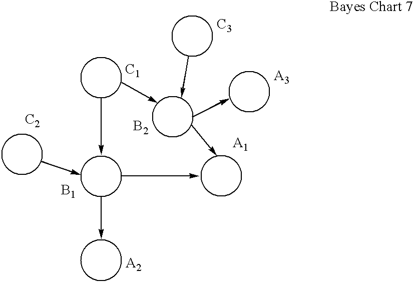

Given that Nᵢ is statistically the number of times the worker moving from Node Cᵢ according to the history record, the probability of the worker moving to Node Cᵢ is defined by the following Equation 9:

$$P ( {C}_{i} ) = \frac{{N}_{i}}{{\sum }_{i = 1}^{n} {N}_{i}} \qquad Equation 9$$

Given that Nᵢₖ is statistically the number of times the worker moving from Node Cᵢ to Node Bₖ according to the history record, the probability of the worker moving from Node Cᵢ to Node Bₖ is defined by the following Equation 10:

$$P ( {B}_{k} \vert {C}_{i} ) = \frac{{N}_{ik}}{{\sum }_{k = 1}^{l} {N}_{ik}} \qquad Equation 10$$

Given that Nⱼᵢₖ is statistically the number of times the worker taking the route Cᵢ->Bₖ->Aⱼ according to the history record, the probability of the worker moving from Node Cᵢ to Node Bₖ and then to Node Aⱼ is defined by the following Equation 11:

$$P ( {A}_{j} \vert {B}_{k} ⋂ {C}_{i} ) = \frac{{N}_{jik}}{{\sum }_{j = 1}^{m} {N}_{jik}} \qquad Equation 11$$

Thus, the probability of the worker arriving at Node Aⱼ is defined by the following Equation 12:

$$P ( {A}_{j} ) = {\sum }_{i = 1}^{n} {\sum }_{k = 1}^{l} P ( {A}_{j} \vert {B}_{k} ⋂ {C}_{i} ) \times P ( {B}_{k} \vert {C}_{i} ) \times P ( {C}_{i} ) \qquad Equation 12$$

Therefore, the probability of the worker moving from Node Cᵢ to Node Bₖ and arriving at Node Aⱼ is defined by the following Equation 13:

$$\begin{matrix}P ( {B}_{k} ⋂ {C}_{i} \vert {A}_{j} ) = \frac{P ( {A}_{j} \vert {B}_{k} ⋂ {C}_{i} ) \times P ( {B}_{k} ⋂ {C}_{i} )}{P ( {A}_{j} )} \\ = \frac{P ( {A}_{j} \vert {B}_{k} ⋂ {C}_{i} ) \times P ( {B}_{k} \vert {C}_{i} ) \times P ( {C}_{i} )}{P ( {A}_{j} )}\end{matrix} \qquad Equation 13$$

Even in the condition that no catastrophe happens and it is not necessary for the worker to move to the entrance, the above-described model is still applicable to forecast the location of the worker. For example, the following Bayes Chart 8 simulates a normal condition without a catastrophe.

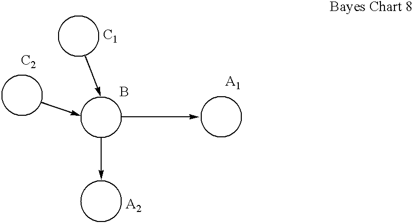

Given that Nᵢⱼ is statistically the number of times the worker taking the route Cᵢ->B->Aⱼ according to the history record, the probability of the worker moving from Node Cᵢ to Node B and then to Node Aⱼ is defined by the following Equation 14:

$$P ( {A}_{j} \vert B ⋂ {C}_{i} ) = \frac{{N}_{ij}}{{\sum }_{j = 1}^{m} {N}_{ij}} \qquad Equation 14$$

Based on the output of the Bayesian network model and preferably of the location constraints model, the location the mineworkers can be forecasted. When a catastrophe happens, the predicted location is transmitted to the rescue force for a prompt rescue of the trapped workers.

In addition, the output data of the location probability of every single worker can be transmitted to a route optimization engine, which functions to execute a route optimization algorithm and create an optimal moving route for each worker based on the output data corresponding to each worker. The optimal route can be shortest, safest, or least congested route. For example, the optimal route is created by statistically processing the output data and other parameters by applying a statistical model.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A method for forecasting the location of a mobile object in a network by utilizing Radio Frequency Identification (RFID) technology, wherein the network consists of a plurality of nodes connected with each other, at lease one RFID reader having a monitoring range is disposed at each node of the network and at least one RFID tag is physically attached to the mobile object, said method comprising the steps of:
generating a record data related to the mobile object when the mobile object moves within the monitoring range of an RFID reader disposed at a node; and
statistically processing the record data to estimate the location of the mobile object.

2. The method of claim 1, wherein statistically processing the record data to estimate the location of the mobile object comprises generating a statistical model and applying the statistical model to the record data.

3. The method of claim 2, wherein generating a statistical model and applying the statistical model to the record data comprises generating a Bayesian network model based on the network and applying the Bayesian network model to the record data.

4. The method of claim 1, wherein statistically processing the record data to estimate the location of the mobile object comprises generating a location constraints model dependent on a plurality of parameters and applying the location constraints model to the record data.

5. The method of claim 4, wherein said plurality of parameters is selected from the group consisting of moving velocity of the mobile object, moving history of the mobile object, conditions of the network, time for forecasting the location of the mobile object and any combination thereof.

6. The method of claim 1, wherein the record data related to the mobile object when the mobile object moves within the monitoring range of an RFID reader disposed at a node comprises record data related to the current location of the mobile object when the mobile object moves within the monitoring range of the RFID reader.

7. The method of claim 1, further comprising generating an output data corresponding to the estimated location of the mobile object and transmitting the output data to a display.

8. The method of claim 1, further comprising generating an output data corresponding to the estimated location of the mobile object and transmitting the output data to a route optimization engine for creating an optimal moving route for the mobile object based on the output data.

9. A computer readable medium having computer readable program for operating on a computer for forecasting the location of a mobile object in a network by utilizing Radio Frequency Identification (RFID) technology, wherein the network consists of a plurality of nodes connected with each other, at lease one RFID reader having a monitoring range is disposed at each node of the network and at least one RFID tag is physically attached to the mobile object, said method comprising the steps of:
generating a record data related to the mobile object when the mobile object moves within the monitoring range of an RFID reader disposed at a node; and
statistically processing the record data to estimate the location of the mobile object.

10. The computer readable medium of claim 9, wherein statistically processing the record data to estimate the location of the mobile object comprises generating a statistical model and applying the statistical model to the record data.

11. The computer readable medium of claim 10, wherein generating a statistical model and applying the statistical model to the record data comprises generating a Bayesian network model based on the network and applying the Bayesian network model to the record data.

12. The computer readable medium of claim 9, wherein statistically processing the record data to estimate the location of the mobile object comprises generating a location constraints model dependent on a plurality of parameters and applying the location constraints model to the record data.

13. The computer readable medium of claim 12, wherein said plurality of parameters is selected from the group consisting of moving velocity of the mobile object, moving history of the mobile object, conditions of the network, time for forecasting the location of the mobile object and any combination thereof.

14. The computer readable medium of claim 9, wherein the record data related to the mobile object when the mobile object moves within the monitoring range of an RFID reader disposed at a node comprises record data related to the current location of the mobile object when the mobile object moves within the monitoring range of the RFID reader.

15. The computer readable medium of claim 9, further comprising generating an output data corresponding to the estimated location of the mobile object and transmitting the output data to a display.

16. The computer readable medium of claim 9, further comprising generating an output data corresponding to the estimated location of the mobile object and transmitting the output data to a route optimization engine for creating an optimal moving route for the mobile object based on the output data.

17. A system for forecasting the location of a mobile object in a network by utilizing Radio Frequency Identification (RFID) technology, wherein the network consists of a plurality of nodes connected with each other, at lease one REID reader having a monitoring range is disposed at each node of the network and at least one RFID tag is physically attached to the mobile object, comprising:
a record data generating component for generating a record data related to the mobile object when the mobile object moves within the monitoring range of an RFID reader disposed at a node; and
a statistically processing component for statistically processing the record data to estimate the location of the mobile object.
